(19) United States
(12) Patent Application Publication
(10) Pub. No.: US 2026/0308384 A1
(43) Pub. Date: Oct. 8, 2026

(54) MID-SHADE RED EFFECT PIGMENT

(71) Applicant: SUN CHEMICAL B.V., Weesp (NL)

(72) Inventors: Aron WOSYLUS, Besigheim (DE); Katharina-Verena DORN, Besigheim (DE); Heinrich WÖLK, Frankenthal (DE)

(73) Assignee: SUN CHEMICAL B.V., Weesp (NL)

(21) Appl. No.: 19/484,178

(22) PCT Filed: May 17, 2024
(86) PCT No.: PCT/EP2024/063747

§ 371 Date: Nov. 13, 2025

(30) Foreign Application Priority Data
May 18, 2023 (EP) 23174178.6

(51) Int. Cl. C09C 1/00

(52) U.S. Cl. CPC C09C 1/0066; C01P 2004/20; C01P 2004/61; C01P 2006/12; C01P 2006/62; C09C 2200/1058; C09C 2200/302; C09C 2200/40

(57) ABSTRACT

The present invention is directed to a mid-shade red effect pigment with high chroma and lightness using a metal as flaky substrate which is coated with a colored absorbing layer of iron oxide or iron-oxide hydroxide.

### FIELD OF THE INVENTION

The present invention is directed to a mid-shade red effect pigment with high chroma and lightness using a metal as flaky substrate which is coated with a colored absorbing layer of iron oxide or iron-oxide hydroxide.

### BACKGROUND OF THE INVENTION

### Background Documents

Wißling et. al. Metalleffekt-Pigmente, 2nd edition, 2013, Vincentz Network GmbH; WO2015040537; US20080249209; WO2013175339

Effect pigments are used in many areas, such as automotive coatings, decorative coatings, plastics, paints, printing inks and cosmetics.

The optical effect is based on the directed reflection of light at predominantly flake-like, parallel-oriented, metallic, or strongly refractive pigment particles. Depending on the composition of the pigment platelets, there can be interference, reflection, and absorption phenomena, which create angular-dependent color and lightness effects. Details are known to the skilled person and can be found, for example, in Wißling et. al. Metalleffekt-Pigmente, 2nd edition, 2013, Vincentz Network GmbH.

Metallic effect pigments are made of platelet-shaped substrates such as aluminum platelets/flakes or metal oxide-coated aluminum platelets/flakes. Platelet-shaped aluminum pigments having a coating of iron oxide are well known and described, for example, in Wißling et. al. Metalleffekt-Pigmente, 2nd edition, 2013, Vincentz Network GmbH. They belong to the class of effect pigments which, by virtue of their particular color properties, have found wide use in the coloration of coatings, paints, printing inks, plastics, ceramic compositions and glazes, and cosmetic preparations.

Iron oxide coated aluminum pigments derive their particular optical profile from a combination of specular reflection at the surface of the aluminum platelet, selective light absorption in the iron oxide layer, and light interference at the film-like surfaces of the iron oxide layer. Light interference leads to a color which is mainly determined by the thickness of the iron oxide coating layer. Pigment powders therefore exhibit colors ranging from pale yellow, green-gold, gold, reddish-gold, red to violet.

Iron oxide coated metallic flakes, especially aluminum-based flakes, are very bright and opaque; that is why they are widely used in automotive coatings. The pigments customarily used in this field are based on aluminum platelets and exhibit a metallic mirror effect. Iron oxide coated aluminum pigments are known for brilliant colors in the golden to red color area.

Iron oxide layers of effect pigments can be provided on the metallic substrate particles by gas phase decomposition of volatile iron compounds in the presence of oxygen and/or water vapor (so-called chemical vapor deposition), or by a wet-chemical coating process (e.g., sol-gel or precipitation process).

EP-A-0 033 457 mentions a process for the preparation of colored effect pigments comprising a metallic substrate whose surface is at least partially covered with an iron oxide, wherein iron pentacarbonyl is oxidized to iron oxide in a fluidized bed of the metallic substrates with oxygen at above 100° C. Effect pigments of a bright-golden to reddish-golden interference color are obtained. They show, for example, in an alkyd melamine resin a golden color exhibiting high brilliance and color purity.

In wet-chemical preparation methods, metal oxide containing layers can be applied by hydrolytic reaction of appropriate metal salts; e.g., iron (III) salts such as iron (III) chloride, sulfate, or nitrate, or hydrolysable organometallic compounds. Details about the preparation of a metal oxide coating layer on a metal-based substrate of an effect pigment are provided, e.g., in EP-A-0 708 154 or JP-A-54081337.

WO-A-2013/156327 refers to a wet-chemical preparation process, wherein an initially formed hydroxyl-containing metal oxide layer on an aluminum or aluminum alloy substrate is subjected to a liquid post-treatment medium at a temperature of at least 90° C.

EP-A-1 553 144 refers to reddish interference pigments based on Fe₂O₃/SnO₂/[Al(P)]), obtained by a wet-chemical process. The pigments show a higher chroma than pigments without an intermediate binder layer of hydrated tin oxide.

WO2015/040537 refers to doping of the metal oxide layers, especially the iron oxide layer, with aluminum. By adding defined amounts of other metal oxides in the metal oxide layer, the color and magnetic properties can be improved.

US2008/0249209 mentions how to surface treat aluminum-based pigments with inorganic layers, hybrid (inorganic-organic) layers, and pure surface functional molecules. The goal was to improve the application profile of the pigments; i.e., gassing stability and compatibility with the paint system.

Aluminum-based pigments coated with iron oxides have inherent safety challenges due to the thermite reaction. Thus, different concepts exist to improve safe-handling of this material, for example, by minimizing aluminum content when handled in dry form (US2019/0144679), maximizing aluminum content (US-A-2007/0034112), or mixing with unreactive material (WO2013/175339).

Aluminum flakes are available in varying quality which can be characterized by particle size distribution (e.g., the average diameter d50 and the broadness of the particle-size curve (Span)), the color properties (e.g., the lightness and hiding power) and the surface area (BET). Typical values of non-VMP-based aluminum flakes are given in Table 2. The basic principles of aluminum flake characterization and production can be found in Wißling et. al. Metalleffekt-Pigmente, 2nd edition, 2013, Vincentz Network GmbH or in Metall- und Effektpigmnte für Lacke, Eckart, 1/January2020.18 CO, 099113XX0. For example, they can be produced via sublimation of metals on foil or via ball-milling of granules, as described in Wißling et. al. Metalleffekt-Pigmente, 2nd edition, 2013, Vincentz Network GmbH.

Aluminum pigments can be characterized by surface area BET, which is measured by gas adsorption and known to the skilled person. The BET relates to average surface area according to the formula described in US-A-2007/0034112 and is derived from simple mathematical/geometrical considerations. The surface area, and thus thickness of ball milled metal flakes are characterized by a distribution in thickness. In contrast, VMP produced metal flakes inhabit a very narrow thickness distribution. The surface area of these thin VMP produced flakes is mainly a result of the upper and lower faces of the flake; the surface area contribution from the side face is negligible as the aspect ratio is high.

The relation between BET and average thickness can be expressed as follows:

TABLE 1
Theoretical relation between average thickness of substrate and the surface
area calculated for a flake of 10 μm and 20 μm in particle diameter.
Smaller flakes with, e.g., 10 μm are overlapping with 20 μm flake and
only become slightly visible for thick flakes.

| | Surface area m²/g | | Hiding of 1 g of Pigment/m² = | |
|---|---|---|---|---|
| Thickness | 10 μm | 20 μm | surface area divided by 2 | |
| of flake/nm | flake | flake | 10 μm flake | 20 μm flake |
| 10 | 74.22 | 74.15 | 37.11 | 37.07 |
| 20 | 37.19 | 37.11 | 18.59 | 18.56 |
| 25 | 29.78 | 29.70 | 14.89 | 14.85 |
| 30 | 24.84 | 24.77 | 12.42 | 12.38 |
| 40 | 18.67 | 18.59 | 9.33 | 9.30 |
| 60 | 12.49 | 12.42 | 6.25 | 6.21 |
| 80 | 9.41 | 9.33 | 4.70 | 4.67 |
| 100 | 7.56 | 7.48 | 3.78 | 3.74 |
| 119 | 6.37 | 6.30 | 3.19 | 3.15 |
| 140 | 5.44 | 5.37 | 2.72 | 2.68 |
| 160 | 4.78 | 4.70 | 2.39 | 2.35 |
| 180 | 4.26 | 4.19 | 2.13 | 2.09 |
| 200 | 3.85 | 3.78 | 1.93 | 1.89 |
| 220 | 3.52 | 3.44 | 1.76 | 1.72 |
| 240 | 3.23 | 3.16 | 1.62 | 1.58 |
| 260 | 3.00 | 2.92 | 1.50 | 1.46 |
| 280 | 2.79 | 2.72 | 1.40 | 1.36 |
| 300 | 2.62 | 2.54 | 1.31 | 1.27 |
| 320 | 2.46 | 2.39 | 1.23 | 1.19 |
| 340 | 2.33 | 2.25 | 1.16 | 1.13 |
| 360 | 2.21 | 2.13 | 1.10 | 1.07 |
| 380 | 2.10 | 2.02 | 1.05 | 1.01 |
| 400 | 2.00 | 1.93 | 1.00 | 0.96 |
| 420 | 1.91 | 1.84 | 0.96 | 0.92 |
| 440 | 1.83 | 1.76 | 0.92 | 0.88 |
| 460 | 1.76 | 1.68 | 0.88 | 0.84 |
| 480 | 1.69 | 1.62 | 0.85 | 0.81 |
| 500 | 1.63 | 1.56 | 0.81 | 0.78 |
| 550 | 1.49 | 1.42 | 0.75 | 0.71 |
| 600 | 1.38 | 1.31 | 0.69 | 0.65 |
| 650 | 1.29 | 1.21 | 0.64 | 0.61 |
| 700 | 1.21 | 1.13 | 0.60 | 0.57 |
| 715 | 1.18 | 1.11 | 0.59 | 0.56 |
| 800 | 1.07 | 1.00 | 0.54 | 0.50 |

Aluminum pigments produced via ball milling of granules are well known to the skilled person (Wißling et. al. Metalleffekt-Pigmente, 2nd edition, 2013, Vincentz Network GmbH). Here the choice of aluminum granules, milling parameters and milling spheres, are key variables that influence the color, lightness values, and hiding of the aluminum pigment.

However, existing colored pigments have shortcomings in the mid-shade red area. For example, the chroma and/or lightness of the existing pigments are insufficient for advanced applications requiring improved coloristic properties such as those found in the automotive coating industry. Access to new color spaces and good performance properties like hiding, appearance, and fastness (in terms of weathering and humidity resistance) may be achieved with pigments having high hiding power, high chroma, and/or high lightness. Since there is a commercial interest for pigments of higher brilliance and hiding in various applications, especially for coating applications, there is a continuing need for improved, especially more chromatic, red effect pigments to increase the accessible color space.

Therefore, it is an object of the present invention to provide a mid-shade red effect pigment having improved coloristic properties, such as chroma and lightness, while retaining good hiding power.

The lightness of metal flakes describes their property to reflect light. As for effect pigments, flakes are selected which orient to the coated substrate and viewing angle. Application methods are important.

To accomplish this, one of skill in the art would try to find the best performing aluminum grades in the market; those with very high hiding and light reflection (i.e., high lightness values L*15). This would naturally lead one to thin aluminum flakes with high surface area like those created via the PVD process. However, the skilled person would exclude vacuum metalized pigments (VMP) as they are difficult to process and not very stable (EP 2 820 089 B1).

TABLE 2
Values of surface area BET, particle size distribution, and coloristic properties
of non-VMP-based aluminum flakes for Inventive and Comparative Examples.

| | | Particle size | | | | | | | | | | |
|---|---|---|---|---|---|---|---|---|---|---|---|---|
| | | (10 min at 30% US)¹ | | | | | | | | | | |
| | BET | D10 | D50 | D90 | | Coloristic properties | | | | | | |
| Aluminum | [m²/g] | [μm] | [μm] | [μm] | Span | h15 | C*15 | L*15 | h25 | C*25 | L*25 | ΣdE |
| Al 1 | 2.58 | 10.3 | 17.7 | 28.4 | 1.0 | 110.2 | 0.7 | 157.2 | 255.7 | 2.8 | 110.3 | 9 |
| (Inv. Ex. 1) | | | | | | | | | | | | |
| Al 2 | 3.13 | 9.5 | 17.1 | 28.6 | 1.1 | 206.2 | 0.5 | 160.3 | 256.4 | 3.3 | 109.9 | 5 |
| (Inv. Ex. 2) | | | | | | | | | | | | |
| Al 3 | 3.55 | 11.7 | 19.5 | 31.0 | 1.0 | 241.9 | 1.1 | 164.1 | 257.7 | 3.5 | 109.7 | 4 |
| (Inv. Ex. 3) | | | | | | | | | | | | |
| Al 4 | 2.94 | 8.8 | 15.2 | 24.9 | 1.1 | 171.9 | 0.4 | 157.3 | 256.0 | 3.0 | 109.6 | 11 |
| (Inv. Ex. 4) | | | | | | | | | | | | |
| Al 5 | 3.64 | 8.3 | 15.2 | 25.6 | 1.1 | 92.7 | 1.4 | 150.3 | 249.3 | 1.4 | 113.6 | 13 |
| (Comp. Ex. 1) | | | | | | | | | | | | |
| Al 6 | 1.84 | 10.5 | 18.7 | 30.6 | 1.1 | 121.3 | 0.4 | 157.5 | 254.1 | 1.5 | 114.7 | 33 |
| (Comp. Ex. 2) | | | | | | | | | | | | |
| Al 7 | 1.45 | 13.5 | 21.8 | 33.9 | 1.0 | 91.3 | 1.3 | 156.7 | 256.9 | 2.5 | 110.5 | 59 |
| (Comp. Ex. 3) | | | | | | | | | | | | |

¹Measured by ultrasound at 30% power output

Table 2 shows typical values of surface area BET, particle size distribution, and coloristic values (hue, chroma, lightness, hiding power (ΣdE)) of non-VMP based aluminum flakes. Typical lightness values of non-VMP-based aluminum flakes range from 150 to about 170 lightness L*15 points.

The relationship between average thickness and hiding power can be seen in Table 1. As shown, as the average thickness of the flake increases, its hiding of 1 g pigment/m² decreases significantly. Thus, based on conventional knowledge, to improve the pigment's hiding power the skilled person would typically use the thinnest metal flakes having the highest surface area at their disposal.

To achieve better effect pigments in the mid-shade red area comprising best hiding power the skilled person would typically use VMP metal flakes as starting material for new effect pigments as they exhibit the highest hiding of 1 g pigment/m² as visualized in Table 1. Considering the simple process of preparation and brittleness of the untreated or coated flake, the skilled person would gravitate to an inferior option—very thin aluminum flakes produced via ball mill which are available in large quantities and are stable against mechanical forces in process and application testing. Thus, the skilled person would use a very thin flake produced by classical ball milling having high surface area aluminum (e.g. >6 m²/g) to get the desired mid-shade red having high brilliance factor and hiding.

Surprisingly, and contrary to common knowledge, inventors found that good hiding and excellent coloristic properties in the mid-shade red region are possible with aluminum flakes which exhibit surface area<6 m²/g, narrow broadness of particle-size curve, good hiding power and high lightness, when coated with passivation layer(s) and absorption layers like Fe₂O₃.

A further object of the present invention is to provide a pigment combination comprising a mid-shade red effect pigment, with improved coloristic properties (such as chroma and lightness) over traditional pigments, while retaining good hiding power in coating applications, especially in orange-to-red hued coatings, and preferably in automotive coatings.

Citation or identification of any document in this application is not an admission that such represents prior art to the present invention.

### DETAILED DESCRIPTION

The present invention relates to a mid-shade red effect pigment with high chroma and lightness in 15° angle using a flaky metal substrate that is coated with a colored absorbing layer containing iron oxide and/or iron-oxide hydroxide (this includes that other elements could be found in iron oxide layers as well, e.g., Mn, Si, Al, Ni . . . ). Optionally, the mid-shade red effect pigment may comprise a passivation layer between the metal substrate and colored absorbing layers.

Surprisingly, even higher Brilliancy Factor (BF) at comparable and very good hiding power is found, which is contrary to the mindset of the skilled person in view of thicker aluminum flakes and thus having higher metal content in the final pigment.

Thus, the invention describes a mid-shade red effect pigment comprising:
h15 of 25°≤h15≤49°; preferred 28°≤h15≤45°.
Chroma spread (C* spread)≥60.
Lightness spread (L* spread)≥90.
Brilliancy Factor (BF)≥140; more preferably ≥145; most preferably ≥150. In one embodiment, the BF would be 140-165, or 145-165, or 150-165.
Hiding power (ΣdE)<110.
Aluminum metal content in dry pigment calculated and the rest calculated as oxides≥26 wt. %, having an upper limit of 60 wt. %.
SiO₂ content≤10 wt. %.
Use of Aluminum flake having a combination of the following characteristics:
   Surface area (BET)≤4 m²/g
   Broadness of particle-size curve (Span)≤1.2
   Hiding power ΣdE<20
   Lightness L*15>153.

Additionally, the invention relates to a method of manufacturing the mid-shade red effect pigment.

Furthermore, the invention relates to the use of said mid-shade red effect pigment for coloring a composition such as a paint, printing ink, varnish, plastics, fibers, films, or cosmetic preparations. In another embodiment, the mid-shade red effect pigment could be used for coloring automotive, architectural, and industrial coating compositions.

The term “mid-shade red effect pigment” means an effect pigment having a red-orange color between 25°≤h15≤45° related to drawdown methods described in the test methods section below. The term “platelet” or “flake” means those substrates having an aspect ratio of 10:1 or higher.

Color may be described in different color space systems. As used herein, the color data C* (chroma), h (hue angle), L* (lightness), a* (red-green axis) and b* (yellow-blue axis) are understood as defined in the CIELAB color measuring system (specified by the Commission Internationale de l'Eclairage). For example, considering a point A in the CIELAB color space, it is defined by the three coordinates L*, a* and b*. The CIELAB coordinates a* and b* may also be expressed by way of cylindrical coordinates C* and h, as known to one skilled in the art.

Metal oxide coated pigments are not only described by the individual color factors but also by lightness spread and chroma spread between face angle and downflop which is defined here by:
Chroma spread (C* spread): C*15 minus C*110.
Lightness spread (L* spread): L*15 minus L*110.

The C*15, C*110, L*15, L*110 values are measured with BYK-mac i Sensor 23 mm, illum. D65 10° device whereas the color is applied in a drawdown as described.

The goal of the invention is to provide mid-shade red pigments having high absolute chroma in face angle (C*15), high absolute lightness in face angle (L*15), high chroma spread, and high lightness spread. As both chroma and lightness take part in the optical differentiation of pigments, they can be combined into one factor called Brilliancy Factor (BF), which is defined as the sum of the chroma spread and the lightness spread, as shown in the following equation:

Brilliancy Factor (BF)=Chroma spread+Lightness spread.

An additional goal of the invention is to maximize the Brilliancy Factor (BF).

Another goal of the invention is to maintain a hiding power below ΣdE=110, which is preferred in automotive coatings.

The metallic substrates may be of a wide range of metals used in the field of effect pigments. The metallic substrate is usually in the form of platelets or flakes. The metallic substrate may be selected from aluminum, steel, silver, copper, gold-bronze (brass), zinc, zirconium, tin, titanium, alloys thereof, and combinations thereof. The metallic substrates are preferably aluminum-based, iron, copper or gold-bronze.

More preferably, the metallic substrate is an aluminum-based substrate. Appropriate aluminum-based substrate particles are generally known to the skilled person. The aluminum-based substrate particles may be made of an aluminum core or aluminum alloy core which may be at least partly coated with one or more passivation layers.

The aluminum or aluminum alloy platelets or flakes may be obtained by means of common atomizing and grinding techniques. Suitable aluminum or aluminum alloy platelets are produced, for example, by the Hall process by wet grinding in white spirit. The starting material is an atomized, irregular aluminum grit which is ball-milled in white spirit and in the presence of lubricant into platelet-shaped particles and subsequently classified. Also, dry grinding of aluminum powder is possible.

The metallic substrate is more preferably aluminum. The aluminum substrate may be of the “cornflake” type or of the “silver dollar” or even “platin dollar” type depending on the quality and shape of the starting granules and on the milling conditions.

Whereas the surface area of the product is defined and describes the average thickness of big amount of flakes the individual thickness of each aluminum flake can be variable and can be determined via crosscut TEM/SEM. Typically, the geometric thickness of the metallic platelets, especially aluminum-based platelets, may be within the range of 10 nm to 1500 nm, preferably 10 to 1000 nm, more preferably 20 to 800 nm, and most preferably 20 to 700 nm.

The average diameter of the platelets, especially aluminum or aluminum alloy platelets, may be within the range of 3 to 100 μm, preferably 5 to 50 μm. Typically, the aspect ratio of average diameter to average thickness may be within the range of 10:1 to 1000:1. The diameter may be determined by laser scattering size determinations.

As mentioned above, the aluminum or aluminum alloy core of the aluminum-based substrate particles may at least partially be coated with one or more passivation layers, for example completely coated with one or more passivation layers. Preferably, the one or more passivation layers cover the aluminum-based platelets completely, including the side faces.

Appropriate passivating layers are generally known to the skilled person. The passivating layer is preferably an inorganic layer such as a metal phosphate layer, or an inorganic oxide layer. If the inorganic passivating layer is a metal phosphate layer, the metal may be selected from Ti, V, Cr, Mn, Fe, Co, Ni, Cu, Zn, Al, Zr, Nb, Mo, Ta or W. If the inorganic passivating layer is an inorganic oxide layer, the oxide may be selected from Ti, V, Cr, Mn, Fe, Co, Ni, Cu, Zn, Al, Zr, Nb, Mo, Ta, W, Ge, Si, Sn and Bi oxides or any combination thereof.

Preferably, the passivating layer is a metal phosphate layer, a silica layer, an aluminum oxide layer, a hydrated aluminum oxide (AlOOH) layer or a combination thereof. More preferably, the passivating layer is a silica layer and an Al-oxide layer.

According to a preferred aspect, the invention relates to a mid-shade red effect pigment, wherein the effect pigment comprises an aluminum substrate which is passivated with a layer of a metal phosphate, silica, aluminum oxide, hydrated aluminum oxide or a combination thereof.

According to the invention an iron oxide layer is applied on an optionally passivated platelet-shaped metallic substrate, preferably an optionally passivated aluminum-based platelet-shaped substrate. The iron oxide layer may be produced by a wet-chemical method, as described later. The wet-chemical coating process is generally performed until the desired interference color is obtained. A thermal treatment transfers the hydroxyl-containing iron oxide layer into a Fe₂O₃-containing layer. The desired final hue after thermal treatment h15 of 25°≤h15≤49°; preferred 28°≤h15≤45°.

Preferably, the optionally passivated metallic platelet-shaped substrates are completely encapsulated by the iron oxide layer.

The geometric thickness of the iron oxide coating, as, for example, obtainable by a wet-chemical process, usually is about 120 to about 500 nm, preferably 130 to 450 nm, more preferably 150 to 350 nm. The geometric layer thickness may be determined on the basis of TEM micrographs (crosscuts).

To get desired effect pigments different layers of, e.g., silicon oxide or iron oxide may be applied. Preferably, the mid-shade red effect pigment has only one iron oxide layer. More Preferably, the mid-shade red effect pigment does not have a further metal oxide layer of high refractive index.

The iron oxide layer may contain up to 20 wt % of other metals, like aluminum, silicon or zirconium or the like, based on the total amount of iron metal atoms in the iron oxide layer. The doping metal concentration in the iron oxide layer may be determined by TEM in combination with EDXS (energy dispersive X-ray spectroscopy), as mentioned, for example, in WO-2015/040537.

Preferably, the iron oxide layer may be doped with up to 10 wt. % of aluminum, based on the total amount of iron and aluminum atoms in the aluminum-doped iron oxide layer. Preferably, the aluminum-doped iron oxide layer contains from 0.05 wt. % to 10 wt. % Al or from 0.5 to 8 wt. % or from 0.5 to 6 wt. %, based on the total amount of Fe and Al atoms in the Al-doped iron oxide layer.

Usually, the Al concentration in the substrate-near part of the Al-doped iron-oxide layer is higher than the Al concentration in the substrate-remote part of the Al-doped iron oxide layer.

In another embodiment the iron oxide layer might contain other elements in addition to aluminum, e.g., silicon. This can be incorporated during coating step of iron oxide hydroxide or at a later stage. Preferably, the iron oxide layer may be doped with up to 15 wt. % of silicon, based on the total amount of iron atoms in the iron oxide layer. Preferably, the iron oxide layer contains from 0.05 wt. % to 15 wt. % Si or from 0.5 to 10 wt. % or from 0.8 to 8 wt. %, based on the total amount of Fe and Si atoms in the iron oxide layer.

In the present invention, it is possible that the iron oxide layer represents the outermost layer of the mid-shade red effect pigment. Alternatively, one or more additional layers may be applied onto the iron oxide layer, such as a SiO₂ layer, a polymer layer, an organosilane layer, or any combination thereof.

The geometric thickness of the final layer may be 2 to about 50 nm, preferably 2 to 30 nm, more preferably 2 to 20 nm, dependent on the kind of surface modification.

In a preferred embodiment, the mid-shade red effect pigment contains a final layer which is selected from a SiO₂ layer, a polymer layer, an organosilane layer, or combinations thereof. The term “final layer” is synonymous with the “outermost layer”. Such surface modification is usually adapted to the particular end-use. With such final layer, surface polarity of the mid-shade red effect pigment may be adjusted, which in turn may improve bonding of the effect pigment to a binder system, for example, of a paint or an ink.

Methods for surface modification of effect pigments and appropriate surface modifying agents such as silanes having surface-reactive functional groups (e.g., alkoxysilanes etc.) are known to the skilled person and may improve compatibility of the effect pigment with the varnish or lacquer. Surface modification methods and agents are described, for example, in EP-A-1682622, EP-A-1904587, WO-A-99/57204, EP-A-1812519 or EP-A-0688833.

The mid-shade red effect pigment may be manufactured by coating optionally passivated platelet-shaped metallic substrates by a wet-chemical method of hydrolytic decomposition of an iron(III) salt in a liquid medium.

Accordingly, a further aspect of the invention relates to a method of manufacturing a mid-shade red effect pigment, as described in any aspect herein, which method comprises
(a) providing an optionally passivated platelet-shaped metallic substrate, and
(b) coating the substrate in a liquid medium comprising an iron oxide precursor compound.

Preferably, the mid-shade red effect pigment obtained or obtainable by the method of the present invention corresponds to the mid-shade red effect pigment, as described herein.

Methods for preparing a passivating layer on a metallic substrate such as aluminum platelets are generally known to the skilled person.

The term “iron oxide” used herein means α-iron(III) oxide in particular. However, the term “iron oxide” also comprises mixtures of α-iron(III) oxide with minor amounts of γ-iron(III) oxide, magnetite (Fe₃O₄), hydrated iron oxide or iron oxide hydroxide (e.g., FeO(OH), Fe₂O₃·H₂O, Fe₂O₃·n H₂O with n≥2. Fe(OH)₃, Fe(OH)₂ or a mixture of two or more of these hydroxyl-containing iron-oxides). Preferably, Fe atoms are present as Fe(III). However, within the present invention Fe atoms may also be present as Fe(II). Preferably, the iron oxide layer comprises Fe₂O₃.

As aluminum metal quickly reacts with air until a thin shell of aluminum oxide is generated. This process is called self-passivation and leads to a thin layer of aluminum oxide Al₂O₃ on top of the metal.

The term “a mixture thereof” or “a combination thereof” means any possible, physically blended mixture or combination of two or more components mentioned in the respective list, either of the same or different kind of components.

Layer thickness is usually determined by transmission electron microscopy (TEM) or scanning electron microscopy (SEM) produced on crosscuts of about 10-50 flakes. As described in U.S. Pat. No. 11,292,917 B2 a thin film of a coating containing the aligned flakes is cut and analyzed via SEM or TEM, wherein the geometric thickness values of about 10-50 platelets are investigated and averaged statistically. Preferred more than 20 different points are measured to get average numbers. Depending on the desired process, different layer thicknesses may be needed. It is known that mid-shade red pigments from chemical vapor processes inhabit a layer of around 120 nm (Ostertag, W. (1994), Effektpigmente. Nachr. Chem. Tech. Lab., 42: 849-854, https://doi.org/10.1002/nadc.19940420907), whereas wet-chemical layers comprising thicker layers to reach this color space.

In the wet-chemical process, appropriate precursor compounds such as organic silicon and/or aluminum compounds in which the organic groups are bonded to the metals via oxygen atoms are typically hydrolyzed in the presence of the substrate particles (e.g., aluminum flakes or platelets) and of an organic solvent in which the metal compounds are soluble. Preferably, a metal alkoxide (especially tetraethoxysilane and aluminum triisopropoxide) is hydrolyzed with water in the presence of an alcohol (e.g., ethanol or 2-propanol) and a basic and/or acid catalyst. Basic catalysts are, for example, aqueous ammonia and/or amines, acid catalysts may be, for example, phosphoric acid or organic acids like acetic acid or oxalic acid. This is preferably done by initially charging substrate particles, ethanol, water and ammonia, heating this mixture to from 40° C. to 90° C., with stirring and continuously adding a solution of the metal alkoxide in ethanol and water or aqueous ammonia. Following a subsequent stirring time of usually from 1 to 15 hours, the mixture is cooled down to room temperature, and the coated pigment is isolated by filtering off, washing and optionally drying. Further details about the method of preparing a passivating layer on aluminum are provided, e.g., in EP-A-0 708 154, DE-A-44 05 492 or WO-A-2011/95341.

The iron oxide layer is usually prepared by a wet-chemical method, for example, by hydrolysis of suitable iron oxide precursor compounds. The coating process is generally performed until the desired interference color is obtained. A thermal treatment transfers the hydroxyl-containing iron oxide layer into a Fe₂O₃-containing layer, preferably a hematite layer.

As indicated above, the substrate is coated in a liquid medium, which comprises an iron oxide precursor compound. Usually, the liquid medium is an aqueous medium, typically containing water in an amount of from 10 to 100 wt. % or from 30 to 100 wt. %, based on the total amount of liquids in the aqueous medium.

The iron oxide precursor compound which may be used for providing an iron oxide layer via wet-chemical process are generally known to the skilled person. Exemplary iron oxide precursor compounds are, for example, iron salts such as iron(III) halides (e.g., FeCl₃), iron(III) nitrate, iron(III) sulfate, hydrolysable iron compounds such as iron alkoxides, complex compounds of iron such as iron acetylacetonate or any combination or mixture thereof.

In principle, the iron oxide layer may be applied onto the substrate at acidic or basic pH. Preferably, the liquid medium has a pH of 5 or less, more preferably 4 to 2. Preferably, the pH of the aqueous medium is kept constant while applying the iron-oxide layer or the Al-doped iron oxide layer on the substrate. The temperature may be varied over a broad range, such as at least 20 to 100° C.

Preferably, the pigment obtained is subsequently subjected to a thermal treatment step, for example drying the pigment and/or effecting further condensation in the iron oxide layer. The thermal treatment step may be carried out by calcination at about 250 to 450° C., preferably 280 to 400° C., for at least 5 min, for example within a period of about 10 to 60 min. Alternatively, the effect pigment obtained may be subjected to a medium comprising one or more high boiling solvents and heating at a temperature of at least 90° C. for at least 0.5 hours.

High boiling solvents usually have a boiling point of from 90 to 400° C., more preferably 100 to 300° C. Examples may be monohydroxyl alcohols, diols or polyols, glycol ethers, polyglycol ethers, polyethylene glycol monoethyl ethers, polypropylene glycols, aldehydes, esters, carbonate esters, organic acids, amides, lactams such as NMP, ketones, ethers, alkanes, halide-substituted alkanes, aromatic compounds, liquid polymers, mineral oils, or mixtures thereof.

Usually, the mid-shade red effect pigment is isolated by known methods, like filtering or by thermal treatment, possibly in combination, and used as a paste.

Accordingly, in a further aspect, the invention relates to a mid-shade red effect pigment, as defined herein, obtainable by a method, which method comprises
(a) providing an optionally passivated platelet-shaped metallic substrate, and
(b) coating the substrate in a liquid medium comprising an iron oxide precursor compound.

For various applications, the mid-shade red effect pigment may be suitably used in a blend with any further pigment, preferably a colored absorption pigment and optionally a conventional effect pigment, which is different from the present mid-shade red effect pigment, to provide a pigment combination.

The pigment combination of the present invention consists of at least two or three components, wherein the effect pigment (a) is the mid-shade red effect pigment, as defined herein, the second pigment (b) is at least one colored absorption pigment, and the optional third pigment (c) is a further effect pigment.

Generally, pigment (b) may be at least one pigment other than an effect pigment or a white pigment. Pigment (b) may be any pigment of any color tone, preferably a pigment having a yellow or red-hued or greenish color tone. A combination with other colored pigments like a black or brown pigment may also be possible to achieve the effect.

Preferably, the colored absorption pigment (b) is any transparent colored absorption pigment of a color tone ranging from green to yellow to violet or even blue dependent on the desired shade of the application, preferably of the desired coating. A combination with other colored pigments like a black or brown pigment may also be possible, for example, a transparent carbon black pigment or transparent black perylene pigments.

The term “transparent pigment” used herein means a pigment that provides coatings which are substantially transparent in the range of 400 to 700 nm, without appreciable scattering of radiation in such wavelengths.

Pigment (b) may be an organic pigment, an inorganic pigment or a mixture thereof. Preferably, pigment (b) has a color tone suitable to shade the present effect pigment, like yellow, red-hued or greenish.

Accordingly, in a preferred aspect, pigment (b) is at least one transparent pigment, especially selected from the group consisting of an organic pigment, an inorganic pigment and a mixture thereof.

Organic colored absorption pigments suitable for the present pigment combination typically comprise organic color and black pigments. Suitable examples include a pigment selected from the group consisting of a monoazo, disazo, disazo condensation, anthanthrone, anthraquinone, anthrapyrimidine, benzimidazolone, quinacridone, quinophthalone, diketopyrrolopyrrole, dithioketopyrrolopyrrole, dioxazine, flavanthrone, indanthrone, isoindoline, isoindolinone, isoviolanthrone, metal complex, perinone, perylene, phthalocyanine, pyranthrone, pyrazoloquinazolone, indigo, thioindigo, triarylcarbonium pigment and a mixture thereof, including a solid solution or a mixed crystal thereof.

Suitable examples include the following:
Monoazo pigments: C.I. Pigment Yellow 1, 3, 62, 65, 73, 74, 97, 183 and 191; C.I. Pigment Orange 5, 38 and 64; C.I. Pigment Red 1, 2, 3, 4, 5, 23, 48:1, 48:2, 48:3, 48:4, 49, 49:1, 51, 51:1, 52:1, 52:2, 53, 53:1, 53:3, 57:1, 58:2, 58:4, 63, 112, 146, 148, 170, 184, 187, 191:1, 210, 245, 247 and 251;
Disazo pigments: C.I. Pigment Yellow 12, 13, 14, 16, 17, 81, 83, 106, 113, 126, 127, 155, 170, 174, 176 and 188; C.I. Pigment Orange 16, 34 and 44;
Disazocondensation pigments: C.I. Pigment Yellow 93, 95 and 128; C.I. Pigment Red 144, 166, 214, 220, 221, 242 and 262; C.I. Pigment Brown 23 and 41;
Anthanthrone pigments: C.I. Pigment Red 168;
Anthraquinone pigments: C.I. Pigment Yellow 147 and 199; C.I. Pigment Red 177;
Anthrapyrimidine pigments: C.I. Pigment Yellow 108;
Benzimidazolone pigments: C.I. Pigment Yellow 120, 151, 154, 180, 181; C.I. Pigment Orange 36 and 72, C.I. Pigment Red 175, 185, 208; C.I. Pigment Violet 32; C.I. Pigment Brown 25;
Quinacridone pigments: C.I. Pigment Orange 48 and 49; C.I. Pigment Red 122, 202, 206 and 209; C.I. Pigment Violet 19;
Quinophthalone pigments: C.I. Pigment Yellow 138;
Diketopyrrolopyrrole pigments: C.I. Pigment Orange 71, 73 and 81; C.I. Pigment Red 254, 255, 264, 270 and 272;
Dioxazine pigments: C.I. Pigment Violet 23 and 37;
Flavanthrone pigments: C.I. Pigment Yellow 24;
Indanthrone pigments: C.I. Pigment Blue 60 and 64;
Isoindoline pigments: C.I. Pigment Yellow 139 and 185; C.I. Pigment Orange 61 and 69, C.I. Pigment Red 260;
Isoindolinone pigments: Isoindolinone pigments: C.I. Pigment Yellow 109, 110 and 173; Pigment Orange 61;
Isoviolanthrone pigments: C.I. Pigment Violet 31;
Metal complex pigments: C.I. Pigment Red 257; C.I. Pigment Yellow 117, 129, 150, 153 and 177; C.I. Pigment Green 8;
Perinone pigments: C.I. Pigment Orange 43; C.I. Pigment Red 194;
Perylene pigments: C.I. Pigment Red 123, 149, 178, 179 and 224; C.I. Pigment Violet 29;
Phthalocyanine pigments: C.I. Pigment Blue 15, 15:1, 15:2, 15:3, 15:4, 15:6, 16;
C.I. Pigment Green 7, 36;
Pyranthrone pigments: C.I. Pigment Orange 51; C.I. Pigment Red 216;
Pyrazoloquinazolone pigments: C.I. Pigment Orange 67 and C.I. Pigment Red 216;
Indigo pigments: C.I. Pigment Red 282;
Thioindigo pigments: C.I. Pigment Red 88 and 181; C.I. Pigment Violet 38;
Triarylcarbonium pigments: C.I. Pigment Red 81, 81:1 and 169; C.I. Pigment Violet 1, 2, 3 and 27; C.I. Pigment Blue 1, 61 and 62; C.I. Pigment Green 1;
C. I. Pigment Yellow 101 (Aldazin yellow);
C.I. Pigment Brown 22.

Preferably, the organic pigment is a yellow to red-hued, green or blue organic pigment, for example a yellow, green, blue, red or orange organic pigment, i.e., a C.I. Pigment Green, C.I. Pigment Yellow, C.I. Pigment Red or C.I. Pigment Orange, selected from an anthraquinone, diketopyrrolopyrrole, isoindolinone, metal complex, perinone, perylene, phthalocyanine pigment, indigo pigment or any mixture thereof, including a solid solution or a mixed crystal.

Especially preferred are C.I. Pigment Yellow 129, Pigment Yellow 110, Pigment Red 168, Pigment Red 177, Pigment Red 179, Pigment Red 282 and any diketopyrrolopyrrole pigment like Pigment Orange 71, Pigment Orange 73, Pigment Red 254, Pigment Red 255, Pigment Red 264, Pigment Red 272 or Pigment Red 291.

Suitable organic pigments are, for example, commercially available under the trademarks Irgazin® Cosmoray Orange L 2950, Irgazin® Rubine L 4025, Irgazin® Rubine L 4030, Irgazin® Orange L2990 HD or D 2905, Irgazin® Red L 3630, Irgazin® Yellow L 2040, Irgazin® Yellow L 0800, Paliogen® Red L 3885, Paliogen Red L 3920, Heliogen® Blue L 6950 or Heliogen Green L 9361. Suitable inorganic pigments may be a transparent yellow iron oxide pigment (C.I. Pigment Yellow 42), a transparent red iron oxide pigment (C.I. Pigment Red 101) or a mixture thereof.

Suitable inorganic black or brown pigments may be carbon black (C.I. Pigment Black 7), graphite (C.I. Pigment Black 10) or chrome iron oxide (C.I. Pigment Brown 29).

Suitable inorganic pigments are, for example, commercially available under the trademark Sicotrans®.

The colored absorption pigment (b) is preferably transparent.

Effect pigment (c) may be any conventional effect pigment known in the art. Effect pigment (c) may be a metal pigment like aluminum flakes or an effect pigment based on transparent substrates, like natural mica, synthetic mica or glass flakes. The transparent substrates are typically coated with one or more layers of metal oxides like TiO₂, TiO₂ (doped with SnO₂), SiO₂ and/or Fe₂O₃ or the like. Preferred are pigments which reflect due to interference and absorption phenomena of thin films golden to red light. The metallic mid-shade red gloss of the opaque mid-shade red effect pigment of the invention can thus be modified with especially semitransparent pigments in a similar color. The coloristic effect is an enrichment of a (two-dimensional) metallic gloss with so-called deepness in a third dimension.

Suitable effect pigments (c) are, for example, commercially available under the trademark Lumina® or Mearlin®.

The weight ratio of the mid-shade red effect pigment (a) to colored absorption pigment (b) and optional effect pigment (c) may be varied in a wide range.

In a further aspect, the invention relates to a pigment combination comprising:
(a) a mid-shade red effect pigment comprising an optionally passivated platelet-shaped metallic substrate and an iron oxide layer, wherein the effect pigment has a hue angle h15 of 25°≤h15≤45°,
(b) a colored absorption pigment, and
(c) optionally a further effect pigment;
wherein the weight ratio of the golden effect pigment (a) to pigment (b) and pigment (c) is of from 95:5 to 5:95, preferably 80:20 to 5:95, more preferably 75:25 to 20:80.

The weight ratio of the mid-shade red effect pigment (a) to pigment (b) and optional pigment (c) is, for example, 95:5, i.e., the amount of 95 wt. % corresponds to the mid-shade red effect pigment, and the amount of 5 wt. % corresponds to the combination of pigments (b) and (c). The weight ratio of pigment (b) and pigment (c) may be from 100:0 to 50:50, preferably 75:25 to 60:40.

Preferably, pigment (b) is a transparent pigment, especially selected from the group consisting of an organic pigment, an inorganic pigment and a mixture thereof.

In particular, the organic pigment is a red-hued organic pigment, for example, a red-hued, green or blue organic pigment selected from an anthraquinone, diketopyrrolopyrrole, isoindolinone, metal complex, perinone, perylene, phtalocyanine, indigo pigment or any mixture thereof, including a solid solution or a mixed crystal.

The inorganic pigment may be a transparent yellow iron oxide pigment (C.I. Pigment Yellow 42), a transparent red iron oxide pigment (C.I. Pigment Red 101) or a mixture thereof.

Pigment (c) may be an effect pigment selected from metal pigments, or effect pigments based on a transparent substrate selected from natural mica, synthetic mica or glass. Preferably, pigment (c) comprises a platelet-shaped substrate selected from natural mica, synthetic mica or glass, which is coated with one or more layers of metal oxides selected from TiO₂, TiO₂ (doped with SnO₂), SiO₂ and/or Fe₂O₃.

Metal pigments may be aluminum-based platelets, preferably aluminum platelets.

The mid-shade red effect pigment (a) may be incorporated into the application system in a customary manner, for example as a slurry or paste.

Accordingly, the present invention provides a composition comprising the mid-shade red effect pigment.

The pigment combination may be incorporated into the application system in a customary manner. The mid-shade red effect pigment (a), as defined herein, may be added as a slurry as well as the optional effect pigment (c). Usually, pigment (b) is added in a pre-dispersed state.

The present effect pigment or the present pigment combination is outstandingly suitable for all pigment end-use applications, especially coloring organic or inorganic materials of natural and synthetic origin, for example,
a) for mass coloring polymers, e.g., in the form of resins, rubber or plastics including films and fibers;
b) for the preparation of paints, paint systems, coating compositions, for example, in automotive, architectural and industrial coating compositions,
c) for inks, printing inks, e.g., digital printing like ink-jet printing, as well as for toners in electro-photography, e.g., for laser printers;
d) as an additive to colorants, such as pigments and dyes;
e) for cosmetic preparations;
and the like.

Paints are aqueous or solvent-borne coating materials, in which the instant pigment combination may be employed. Organic film-forming binders that may be used include all of the binders that are usual in the coatings sector. Examples of binder materials which may be colored with the golden effect pigment or the pigment combination, as defined herein, include more particularly:
oil-based materials (based on linseed oil or polyurethane oils),
cellulose-based materials (NC, CAB, CAP),
materials based on chlorinated rubber,
vinyl materials (based on PVC, PVDF, VC copolymer, polyvinyl acetate, polyvinyl ester dispersion, polyvinyl alcohol, polyvinyl acetal, polyvinyl ether, polystyrene, styrene copolymers),
acrylic materials,
alkyd materials,
saturated polyester materials,
unsaturated polyester materials,
polyurethane materials (one pack, two pack),
epoxy materials,
silicone materials.

The systems are described in detail in D. Stoye, W. Freitag, Paints, Coatings and Solvents, Second Edition, 1998, Wiley-VCH.

Preferably, the mid-shade red effect pigment or the present pigment combination is used in waterborne and solvent-borne coating applications, more preferably in decorative coating compositions like architectural, automotive or industrial coating compositions, for example for any consumer goods.

The mid-shade red effect pigment or the present pigment combination is generally incorporated into their respective application media in a customary way. An article may then be coated with these application media thus pigmented. Said article may be, for example, a vehicle body, an industrial equipment, an architectural facing element, etc.

In case of plastics, the mid-shade red effect pigment or the present pigment combination may also be incorporated for coloring into the application medium in the mass. The articles comprise the mid-shade red effect pigment or the present pigment combination.

Suitable compositions for the cosmetic preparations into which the mid-shade red effect pigment may be introduced are known in the art. The formulations of cosmetics using the mid-shade red effect pigment of the invention are accomplished by measures and methods familiar to the skilled person. The mid-shade red effect pigment or the present pigment combination may be suitably used, for example, in nail varnishes.

In a further aspect, the invention relates to the use of the mid-shade red effect pigment or the pigment combination, as defined in any aspect herein, for coloring or pigmenting coating composition such as a paint, a printing ink, an ink, a varnish, plastics, a fiber, a film or a cosmetic preparation, preferably an automotive, an architectural or an industrial coating composition.

The coating composition may be any decorative coating composition like an automotive, an architectural or an industrial coating composition or a paint. The coating composition, printing ink, ink or paint may be waterborne or solvent-borne. Preferably, the mid-shade red effect pigment or the present pigment combination is used as a colorant for an automotive, architectural, industrial coating composition, a paint, a printing ink, an ink or plastics. In particular, the mid-shade red effect pigment or the present pigment combination is used as a colorant for an automotive OEM or refinish coating composition.

In a further aspect, the invention relates to a coating composition including a paint, a printing ink, an ink, a varnish, plastics, a fiber, a film or a cosmetic preparation, which is colored or pigmented with a mid-shade red effect pigment or a pigment combination, as defined in any aspect herein.

In a further aspect, the invention relates to an article coated with a composition comprising a mid-shade red effect pigment or a pigment combination, as defined in any aspect herein.

Any material of the article may be coated with the composition comprising the mid-shade red effect pigment or the present pigment combination, including such materials as glass, ceramics, plastics, smooth-surfaced composites and metallic substrates. Especially, the composition is particularly adapted for metallic articles or plastic articles. The article may be bare substrate material or, in the case of metal substrates, may be pretreated to impart corrosion resistance as by phosphatizing, or electrocoating like cathodic dip coating, or other similar treatments well known in the art.

A coating comprising the mid-shade red effect pigment or the present pigment combination is especially suitable for a multilayer coating used in the automotive industry. The mid-shade red effect pigment or the present pigment combination is usually incorporated into the basecoat layer of a basecoat/clearcoat coating system, as known in the art.

Accordingly, the invention relates to an automotive coating, which is colored or pigmented with a mid-shade red effect pigment or a pigment combination, as defined in any aspect herein.

In a further aspect, the invention relates to a process for coloring or pigmenting a coating composition such as a paint, a printing ink, an ink, a varnish, plastics, a fiber, a film or a cosmetic preparation, preferably an automotive, an architectural or an industrial coating composition, which method comprises adding thereto a mid-shade red effect pigment or a pigment combination, as defined herein.

The present invention is further illustrated by the following set of embodiments and combinations of embodiments resulting from the dependencies and back-references as indicated. In particular, it is noted that in each instance where a range of embodiments is mentioned, for example in the context of a term such as “The method of any one of embodiments 1 to 5”, every embodiment in this range is meant to be explicitly disclosed for the skilled person, i.e. the wording of this term is to be understood by the skilled person as being synonymous to “The method of any one of embodiments 1, 2, 3, 4 and 5”. Further, it is explicitly noted that the following set of embodiments is not the set of claims determining the extent of protection, but represents a suitably structured part of the description directed to general and specific aspects of the present invention.
1. A mid-shade red effect pigment comprising:
   a plate-shaped metal core;
   a silicon containing passivation layer;
   and an iron oxide containing layer on top of the passivation layer;
   wherein the h15 is in the range of 25°≤h15≤49°, preferably 28°≤h15≤45°;
   the BF is 140-165, preferably 145-165, most preferably 150-165;
   and the hiding power is ΣdE<110.
2. The pigment of embodiment 1, wherein the plate shaped metal core comprises aluminum flake with the following characteristics:
   a. surface area (BET)≤4 m²/g, preferably ≤3.8 m²/g, more preferably ≤3.5 m²/g;
   b. broadness of particle-size curve (Span)≤1.2, preferably ≤1.1;
   c. hiding power ΣdE<20, preferably <15, more preferably <13;
   d. lightness L*15>153, preferably >155.
3. The pigment of embodiment 1, wherein the metal content is 25-60 wt. %; preferably 25-40 wt. %; most preferably 25-38 wt. %.
4. The pigment of embodiment 1, wherein the chroma spread is ≥60.
5. The pigment of embodiment 1, wherein the lightness spread is ≥90.
6. The pigment of any preceding embodiment, wherein the average particle size d50 is ≥16 μm.
7. The pigment of any preceding embodiment, wherein the iron oxide layer contains other metal ions individually ≤10 wt. %.
8. The pigment of any preceding embodiment, comprising one or more additional layers applied onto the iron oxide layer.
9. The pigment according to any preceding embodiment, wherein the iron oxide layer has an average thickness of 150 to 350 nm.
10. The pigment of any preceding embodiment, wherein the pigment comprises one or more additional layers on the iron oxide layer selected from the group consisting of a silica layer, an organosilane layer, a polymer layer, or any combination thereof.
11. The pigment of embodiment 10, wherein the additional layer comprises SiO₂ in an amount ≤10 wt. %.
12. A method of making the mid-shade red effect pigment of any one or more of embodiments 1-9, wherein the aluminum flake is produced by a ball milling process.

### EXAMPLES

The invention is further described by the following non-limiting examples which further illustrate the invention, and are not intended, nor should they be interpreted to, limit the scope of the invention.

### Measurement Test Methods

### Hiding Power ΣdE: (Drawdown Method for Hiding Power)

0.044 g of dry aluminum substrate or 0.088 g of dry coated compound, e.g., with an iron oxide layer, is added to 4 g lacquer (87 parts ZM26-3025 Colorclassic plus 13 parts of ZC15-100E CAB solution adjusted to 36 parts DIN 4 with Xylol/Butyl acetate (30:70)) and mixed in a 25 mL-SpeedMixer-Vial in a Hauschild SpeedMixer DAC 150.1 FVZ-K at 3000 rpm for 1 min. The mixture is immediately applied on a Leneta Form 14H Opacity chart black/white by using an Erichsen Knochenrakel Modell 288 125 μm on a film application machine Erichsen Coatmaster 510 with a speed of 18 mm/s at room temperature=21° C. The Leneta Opacity chart was locked into position on the Erichsen Coatmaster by utilizing a vacuum suction plate on top of it. The chart is dried in a fume hood for 2 days at room temperature=21° C. before measurement with a multi-angle color & effect measurement device BYK-mac I Sensor 23 mm, illum. D65 10° by measuring five times on each part, black and white. The hiding power is calculated as ΣdE=dE(15°)+dE(25°)+dE(45°)+dE(75°)+dE(110°).

### BET:

Approximately 1.5-2.0 g of dry, solvent-free product are filled into the 9 mm cuvette sample holder of the surface area analysis device Quantachrome Nova 4000e. The exact sample amount is evaluated by weighing the empty cuvette at room temperature, heating the filled cuvette to 100° C. for 30 min under vacuum and re-weighing it at the same room temperature. A 5-point measurement is then conducted in the analysis station of the Quantachrome device under nitrogen and at relative pressures of 0.10/0.15/0.20/0.25 and 0.30 P/Po. The BET value is automatically calculated by the device and given in the unit m²/g.

### Particle Size:

The sample is pre-dispersed in isopropanol before being placed into the measuring cell Hydro MV of a Panalytical Malvern Mastersizer 3000. The measurement is conducted at 30% US for 10 min in the isopropanol for aluminum substrates and at 10% US for 2 min in the isopropanol for coated compounds, e.g., with an iron oxide layer. Based on that measurement one can define an average particle size d50 and a broadness of the distribution curve which is described here as broadness of particle size distribution (span)=(d90−d10)/d50. Typical values of d50 used are in the region of d50=5-50 μm and more preferred for automotive coatings 8-30 μm and even more preferred 9-25 μm.

### Hue, Chroma and Lightness: (Drawdown Method for Hue, Chroma and Lightness)

0.88 g of dry pigment is given in 4 g lacquer (87 parts ZM26-3025 Colorclassic plus 13 parts of ZC15-100E CAB solution adjusted to 36 parts DIN 4 with Xylol/Butyl acetate (30:70)) and mixed in a 25 mL-SpeedMixer-Vial in a Hauschild SpeedMixer DAC 150.1 FVZ-K at 3000 rpm for 1 min. The mixture is immediately applied on a BYK byko-chart plain white WH 2828 by using an Erichsen Knochenrakel Modell 288 125 μm on a film application machine Erichsen Coatmaster 510 with a speed of 18 mm/s at room temperature=21° C. The BYK byko-chart was locked into position on the Erichsen Coatmaster by utilizing a vacuum suction plate on top of it. The chart is dried in a fume hood for 2 days at room temperature=21° C. before measurement with a multi-angle color & effect measurement device BYK-mac i Sensor 23 mm, illum. D65 10° at 5 points spread over the middle part of the film application.

### Chemical Analysis:

Conducted in an Agilent ICP-OES Model 5100 in order to determine the amount of elemental Al, Si, Fe and Sn in g per 100 g of dry pigment. The amount of oxides, SiO₂, Fe₂O₃ and SnO₂, is calculated as follows via molar mass M and mass m: m(SiO₂)=m(Si)·M(SiO₂)·M(Si)⁻¹, m(Fe₂O₃)=m(Fe)·M(Fe₂O₃)·(2 M(Fe))⁻¹, and m(SnO₂)=m(Sn)·M(SnO₂)·M(Sn)⁻¹. Wt % of Al, SiO₂, Fe₂O₃ and SnO₂ is further calculated as m(x)·100 (m(Al)+m(SiO₂)+m(Fe₂O₃)+m(SnO₂))¹ whereas x=Al, SiO₂, Fe₂O₃ or SnO₂.

TABLE 3
Chemical analysis of red effect pigments based on aluminum flakes.

| | wt % | wt % | wt % | wt % | |
|---|---|---|---|---|---|
| | Al | SiO₂ | Fe₂O₃ | SnO₂ | Total |
| Inv. Ex. 1 | 30.5 | 8.6 | 60.9 | — | 100.0 |
| CQV Stellar Red | 18.1 | 12.7 | 69.2 | — | 100.0 |
| AE-6615-OP | | | | | |
| (Comp.) | | | | | |
| Merck Meoxal | 26.4 | 10.0 | 62.1 | 1.5 | 100.0 |
| Victoria Red F120-51 | | | | | |
| (Comp.) | | | | | |
| Sun Chemical Paliocrom | 27.4 | 10.4 | 62.2 | — | 100.0 |
| Brilliant Red L3258 | | | | | |
| (Comp.) | | | | | |
| Sun Chemical Paliocrom | 65.0 | — | 35.0 | — | 100.0 |
| Sparkling Red L3505 | | | | | |
| (Comp.) | | | | | |

Table 3 contains measurements of dry pigments according to the method described in Chemical analysis. The measured numbers for the elements Fe, Si and Sn are recalculated as a result from SiO₂, Fe₂O₃ and SnO₂. Aluminum is calculated as being metal aluminum. Finally, the calculated numbers for Al and the oxides are normalized to 100%.

TABLE 4
Basic particle sizes and coloristic properties of pigments which are
state of the art, Inventive Examples, or Comparative Examples.

| | Particle size | | | | | | | | | | | | |
|---|---|---|---|---|---|---|---|---|---|---|---|---|---|
| | (2 min at 10% US)¹ | | | Coloristic properties | | | | | | | | | |
| | D10 | D50 | D90 | | | | | | | | C* | L* | |
| Example | [μm] | [μm] | [μm] | h15 | C*15 | L*15 | h110 | C*110 | L*110 | ΣdE | spread | spread | BF |
| CQV | 10.3 | 16.3 | 24.9 | 35 | 79 | 99 | 39 | 24 | 13 | 97 | 55 | 86 | 141 |
| Stellar Red | | | | | | | | | | | | | |
| AE-6615- | | | | | | | | | | | | | |
| OP (Comp.) | | | | | | | | | | | | | |
| Merck | 10.2 | 18 | 29.8 | 34 | 71 | 89 | 44 | 25 | 16 | 111 | 46 | 73 | 119 |
| Meoxal | | | | | | | | | | | | | |
| Victoria | | | | | | | | | | | | | |
| Red F120- | | | | | | | | | | | | | |
| 51 (Comp.) | | | | | | | | | | | | | |
| Sun | 9.8 | 16.1 | 25.9 | 36 | 75 | 95 | 41 | 25 | 14 | 98 | 50 | 81 | 131 |
| Chemical | | | | | | | | | | | | | |
| Paliocrom | | | | | | | | | | | | | |
| Brilliant | | | | | | | | | | | | | |
| Red L3258 | | | | | | | | | | | | | |
| (Comp.) | | | | | | | | | | | | | |
| Sun | 11.6 | 20.1 | 33.4 | 27 | 74 | 103 | 35 | 27 | 12 | 127 | 47 | 91 | 138 |
| Chemical | | | | | | | | | | | | | |
| Paliocrom | | | | | | | | | | | | | |
| Sparkling | | | | | | | | | | | | | |
| Red L3505 | | | | | | | | | | | | | |
| (Comp.) | | | | | | | | | | | | | |
| Inv. Ex. 1 | 10.8 | 18.2 | 29.3 | 35 | 89 | 102 | 37 | 23 | 11 | 108 | 66 | 91 | 157 |
| Inv. Ex. 2 | 10.1 | 17.8 | 29.8 | 39 | 89 | 104 | 39 | 23 | 11 | 104 | 66 | 93 | 159 |
| Inv. Ex. 3 | 12.5 | 20.8 | 33.5 | 37 | 83 | 104 | 40 | 22 | 11 | 105 | 61 | 93 | 154 |
| Inv. Ex. 4 | 9.5 | 15.9 | 25.7 | 37 | 88 | 102 | 37 | 23 | 11 | 104 | 65 | 91 | 156 |
| Comp. Ex. 1 | 9.4 | 16.2 | 26.4 | 34 | 74 | 96 | 38 | 25 | 14 | 98 | 49 | 82 | 131 |
| Comp. Ex. 2 | 10.5 | 18.6 | 29.9 | 36 | 81 | 100 | 39 | 26 | 12 | 112 | 55 | 88 | 143 |
| Comp. Ex. 3 | 13.8 | 22 | 34.2 | 35 | 88 | 103 | 40 | 24 | 11 | 131 | 64 | 92 | 156 |

¹Measured by ultrasound at 10% power output

Table 4 describes the pigments which are state of the art (CQV Stellar Red, Merck Meoxal Victoria Red, Sun Chemical Paliocrom Brilliant Red, Sun Chemical Paliocrom Sparkling Red, Comp. Ex. 1, Comp. Ex. 2, Comp. Ex. 3) versus the inventive pigments (Inventive Examples 1-4) with their basic properties: Particle size distribution; Coloristic properties h15, C*15, L*15, h110, C* 110, L*110; Hiding Power (ΣdE); Chroma spread (C* spread); Lightness spread (L* spread); and Brilliancy Factor (BF).

### Inventive Example 1

a) Aluminum Al 1 (140 g dry powder) as described in Table 2 is suspended in 1300-1600 mL ethanol. SiO₂-passivation takes place according to the method described in Example 1 U.S. Pat. No. 5,607,504 or EP-A-0708154 or JP-A-54081337. The obtained suspension of passivated aluminum, ethanol, ammonia, water, and non-hydrolyzed/partially hydrolyzed tetraethoxysilane is filtered, and washed with 1500 mL ethanol in total. The received paste has a solids concentration of 50 to 60% and the dry pigment has an Al to SiO₂ weight ratio of about 4:1 as described in Table 3.
b) The SiO₂-coated aluminum paste (75-100 g of dry powder) is dispersed in 700 mL of demineralized water and the stirred slurry is heated to 73-78° C. The pH value is set to 3.35 with 10 wt.-% HNO₃, adjusted to 3.1 with a solution of 0.2-0.3 g Al₂(SO₄)₃·16H₂O in 30 mL of demineralized water, and kept at 2.8 with 25 wt.-% NaOH during the addition of Fe(NO₃)₃ solution with an Fe weight concentration of 6-9% until the desired red color is achieved. Typical dosing times are in the range of 12-25 h and the final pigment has an Al:SiO₂:Fe₂O₃ content of about 4:1:7 as described in Table 3. The slurry is filtered, washed twice with demineralized water for small samples or until conductivity level of e.g. 200 μS is achieved and ethanol or isopropanol and the press cake is dried over vacuum for 2-20 h at room temperature for small samples or kept as alcoholic paste with a solid concentration of 60 to 80% to be used in next step when bigger samples are made.
c) Small samples of dry pigment are annealed at 240° C. in a drying chamber for 3 h. Bigger samples of the obtained pigment paste (45-60 g of dry powder) is dispersed in 730-750 g of isoparaffinic fluid. The reaction mixture is heated up to 195-220° C. in 10 h and stirred at 195-220° C. for 6 hours under nitrogen atmosphere. The slurry is filtered, washed with ethanol and the press cake is dried over vacuum for further 5 minutes at room temperature. The received paste has a solid concentration of about 60 to 80%.

### Inventive Example 2

a) Aluminum Al 2 (145 g dry powder) as described in Table 2 is suspended in 1300-1600 mL ethanol. SiO₂-passivation takes place according to the method described in Example 1 U.S. Pat. No. 5,607,504 or EP-A-0708154 or JP-A-54081337. The obtained suspension of passivated aluminum, ethanol, ammonia, water, and non-hydrolyzed/partially hydrolyzed tetraethoxysilane is filtered, and washed with 1500 mL ethanol in total. The received paste has a solids concentration of 50 to 60% and the dry pigment has an Al to SiO₂ weight ratio of about 4:1.
b) The SiO₂-coated aluminum paste (75-100 g of dry powder) is dispersed in 700 mL of demineralized water and the stirred slurry is heated to 73-78° C. The pH value is set to 3.35 with 5-10 wt.-% HNO₃, adjusted to 3.1 with a solution of 0.2-0.4 g Al₂(SO₄)₃·16 H₂O in 30 mL of demineralized water, and kept at 2.8 with 25 wt.-% NaOH during the addition of Fe(NO₃)₃ solution with an Fe weight concentration of 6-9% until the desired red color is achieved. Typical dosing times are in the range of 12-25 h and the final pigment has an Al:SiO₂:Fe₂O₃ content of about 4:1:7. The slurry is filtered, washed twice with demineralized water for small samples or until conductivity level of e.g. 200 μS is achieved and ethanol or isopropanol and the press cake is dried over vacuum for 2-20 h at room temperature for small samples or kept as alcoholic paste with a solid concentration of 60 to 80% to be used in next step when bigger samples are made.
c) Small samples of dry pigment are annealed at 240° C. in a drying chamber for 3 h. Bigger samples of the obtained pigment paste (60 g of dry powder) is dispersed in 730-750 g of isoparaffinic fluid. The reaction mixture is heated up to 195-220° C. in 10 h and stirred at 195-220° C. for 6 hours under nitrogen atmosphere. The slurry is filtered, washed with ethanol and the press cake is dried over vacuum for further 5 minutes at room temperature. The received paste has a solid concentration of about 60 to 80%.

### Inventive Example 3

a) Aluminum Al 3 (140 g dry powder) as described in Table 2 is suspended in 1300-1600 mL ethanol. SiO₂-passivation takes place according to the method described in Example 1 U.S. Pat. No. 5,607,504 or EP-A-0708154 or JP-A-54081337. The obtained suspension of passivated aluminum, ethanol, ammonia, water, and non-hydrolized/partially hydrolyzed tetraethoxysilane is filtered, and washed with 1500 mL ethanol in total. The received paste has a solid concentration of 50 to 60% and the dry pigment has an Al to SiO₂ weight ratio of about 3:1.
b) The SiO₂-coated aluminum paste (100 g of dry powder) is dispersed in 700 mL of demineralized water and the stirred slurry is heated to 73° C. The pH value is set to 3.35 with 5-10 wt.-% HNO₃, adjusted to 3.1 with a solution of 0.45 g Al₂(SO₄)₃·16 H₂O in 30 mL of demineralized water, and kept at 2.8 with 25 wt.-% NaOH during the addition of Fe(NO₃)₃ solution with an Fe weight concentration of 6-9% until the desired red color is achieved. Typical dosing times are in the range of 12-25 h and the final pigment has an Al:SiO₂:Fe₂O₃ content is about 3:1:6.5. The slurry is filtered, washed twice with demineralized water for small samples and ethanol or isopropanol and the press cake is dried over vacuum for 2-20 h at room temperature for small samples.
c) Small samples of dry pigment are annealed at 240° C. in a drying chamber for 3 h.

### Inventive Example 4

a) Aluminum Al 4 (140 g dry powder) as described in Table 2 is suspended in 1300-1600 mL ethanol. SiO₂-passivation takes place according to the method described in Example 1 U.S. Pat. No. 5,607,504 or EP-A-0708154 or JP-A-54081337. The obtained suspension of passivated aluminum, ethanol, ammonia, water, and non-hydrolized/partially hydrolyzed tetraethoxysilane is filtered, and washed with 1500 mL ethanol in total. The received paste has a solid concentration of 50 to 60% and the dry pigment has an Al to SiO₂ weight ratio of about 3:1.
b) The SiO₂-coated aluminum paste (100 g of dry powder) is dispersed in 700 mL of demineralized water and the stirred slurry is heated to 73° C. The pH value is set to 3.35 with 5-10 wt.-% HNO₃, adjusted to 3.1 with a solution of 0.4 g Al₂(SO₄)₃·16H₂O in 30 mL of demineralized water, and kept at 2.8 with 25 wt.-% NaOH during the addition of Fe(NO₃)₃ solution with an Fe weight concentration of 6-9% until the desired red color is achieved. Typical dosing times are in the range of 12-25 h and the final pigment has an Al:SiO₂:Fe₂O₃ content of about 3:1:7. The slurry is filtered, washed twice with demineralized water for small samples and ethanol or isopropanol and the press cake is dried over vacuum for 2-20 h at room temperature for small samples.
c) Small samples of dry pigment are annealed at 240° C. in a drying chamber for 3 h.

### Comparative Example 1

a) Aluminum Al 5 (140 g dry powder) as described in Table 2 is suspended in 1300-1600 mL ethanol. SiO₂-passivation takes place according to the method described in Example 1 U.S. Pat. No. 5,607,504 or EP-A-0708154 or JP-A-54081337. The obtained suspension of passivated aluminum, ethanol, ammonia, water, and non-hydrolized/partially hydrolyzed tetraethoxysilane is filtered, and washed with 1500 mL ethanol in total. The received paste has a solids concentration of 50 to 60% and the dry pigment has an Al to SiO₂ weight ratio of about 3:1.
b) The SiO₂-coated aluminum paste (75 g of dry powder) is dispersed in 700 mL of demineralized water and the stirred slurry is heated to 73-78° C. The pH value is set to 3.35 with 10 wt.-% HNO₃, adjusted to 3.1 with a solution of 0.3-0.45 g Al₂(SO₄)₃·16H₂O in 30 mL of demineralized water, and kept at 2.8 with 25 wt.-% NaOH during the addition of Fe(NO₃)₃ solution with an Fe weight concentration of 6-9% until the desired red color is achieved. Typical dosing times are in the range of 12-25 h and the final pigment has an Al:SiO₂:Fe₂O₃ of about 3:1:6 content. The slurry is filtered, washed twice with demineralized water for small samples or until conductivity level of e.g. 200 μS is achieved and ethanol or isopropanol and the press cake is dried over vacuum for 2-20 h at room temperature for small samples or kept as alcoholic paste with a solid concentration of 60 to 80% to be used in next step when bigger samples are made.
c) Small samples of dry pigment are annealed at 240° C. in a drying chamber for 3 h. Bigger samples of the obtained pigment paste (60 g of dry powder) is dispersed in 730-750 g of isoparaffinic fluid. The reaction mixture is heated up to 195-220° C. in 10 h and stirred at 195-220° C. for 6 hours under nitrogen atmosphere. The slurry is filtered, washed with ethanol and the press cake is dried over vacuum for further 5 minutes at room temperature. The received paste has a solid concentration of about 60 to 80%.

### Comparative Example 2

a) Aluminum Al 6 (140 g dry powder) as described in Table 2 is suspended in 1300-1600 mL ethanol. SiO₂-passivation takes place according to the method described in Example 1 U.S. Pat. No. 5,607,504 or EP-A-0708154 or JP-A-54081337. The obtained suspension of passivated aluminum, ethanol, ammonia, water, and non-hydrolized/partially hydrolyzed tetraethoxysilane is filtered, and washed with 1500 mL ethanol in total. The received paste has a solids concentration of about 70% and the dry pigment has an Al to SiO₂ weight ratio of about 4.5:1.
b) The SiO₂-coated aluminum paste (75 g of dry powder) is dispersed in 700 mL of demineralized water and the stirred slurry is heated to 73° C. The pH value is set to 3.35 with 10 wt.-% HNO₃, adjusted to 3.1 with a solution of 0.3-0.45 g Al₂(SO₄)₃·16H₂O in 30 mL of demineralized water, and kept at 2.8 with 25 wt.-% NaOH during the addition of Fe(NO₃)₃ solution with an Fe weight concentration of 6-9% until the desired red color is achieved. Typical dosing times are in the range of 12-25 h and the final pigment has an Al:SiO₂:Fe₂O₃ ratio of about 4.5:1:7. The slurry is filtered, washed twice with demineralized water for small samples and ethanol or isopropanol and the press cake is dried over vacuum for 2-20 h at room temperature for small samples.
c) Small samples of dry pigment are annealed at 240° C. in a drying chamber for 3 h.

### Comparative Example 3

a) Aluminum Al 7 (140 g dry powder) as described in Table 2 is suspended in 1300-1600 mL ethanol. SiO₂-passivation takes place according to the method described in Example 1 U.S. Pat. No. 5,607,504 or EP-A-0708154 or JP-A-54081337. The obtained suspension of passivated aluminum, ethanol, ammonia, water, and non-hydrolized/partially hydrolyzed tetraethoxysilane is filtered, and washed with 1500 mL ethanol in total. The received paste has a solids concentration of about 80% and the dry pigment has an Al to SiO₂ weight ratio of about 7:1.
b) The SiO₂-coated aluminum paste (100 g of dry powder) is dispersed in 700 mL of demineralized water and the stirred slurry is heated to 73° C. The pH value is set to 3.35 with 10 wt.-% HNO₃, adjusted to 3.1 with a solution of 0.1-0.2 g Al₂(SO₄)₃·16H₂O in 30 mL of demineralized water, and kept at 2.8 with 25 wt.-% NaOH during the addition of Fe(NO₃)₃ solution with an Fe weight concentration of 6-9% until the desired red color is achieved. Typical dosing times are in the range of 12-25 h and the final pigment has an Al:SiO₂:Fe₂O₃ ratio of about 7:1:9. The slurry is filtered, washed twice with demineralized water for small samples and ethanol or isopropanol and the press cake is dried over vacuum for 2-20 h at room temperature for small samples.
c) Small samples of dry pigment are annealed at 240° C. in a drying chamber for 3 h.

1. A mid-shade red effect pigment having a red-orange color between 25°≤h15≤45° comprising:
a plate-shaped metal core;
a silicon containing passivation layer on top of the plate-shaped metal core;
and an iron oxide and/or iron-oxide hydroxide containing layer on top of the passivation layer;
wherein the hue angle h15 is in the range of 25°≤h15≤45° the Brilliancy Factor BF is 140-165;
and the hiding power is ΣdE<110;
wherein the plate shaped metal core comprises aluminum flakes with the following characteristics:
a. surface area (BET)≤4 m²/g;
b. broadness of particle-size curve (Span)≤1.2;
c. hiding power ΣdE<20;
d. lightness L*15>153.

2. The pigment of claim 1, wherein the metal content is 25-60 wt. %.

3. The pigment of claim 1, wherein the chroma spread is ≥60, the chroma spread between face angle and downflop being defined by Chroma spread (C* spread): C*15 minus C*110.

4. The pigment of claim 1, wherein the lightness spread is ≥90, the lightness spread between face angle and downflop being defined by Lightness spread (L* spread): L*15 minus L*110.

5. The pigment of claim 1, wherein the average particle size d50 is ≥16 μm.

6. The pigment of claim 1, wherein the iron oxide and/or iron-oxide hydroxide layer contains other metal ions and/or metals individually ≤10 wt. %.

7. The pigment of claim 1, wherein the iron oxide and/or iron-oxide hydroxide layer has a thickness or an average thickness of 150 to 350 nm.

8. The pigment of claim 1, comprising one or more additional layers applied onto the iron oxide and/or iron-oxide hydroxide layer.

9. The pigment of claim 8, wherein the pigment comprises one or more additional layers on the iron oxide and/or iron-oxide hydroxide layer, selected from the group consisting of a silica layer, an organosilane layer, a polymer layer, or any combination thereof.

10. The pigment of claim 8, wherein the additional layer comprises SiO₂ in an amount of ≤10 wt. %.

11. The pigment of claim 1, wherein the aluminum flake is produced by a ball milling process.

12. The pigment of claim 1, wherein the hue angle h15 is in the range of 28°≤h15≤45°.

13. The pigment of claim 1, wherein the Brilliancy Factor BF is 145-165.

14. The pigment of claim 13, wherein the Brilliancy Factor BF is 150-165.

15. The pigment of claim 1, wherein the aluminum flakes have a surface area (BET)≤3.8 m²/g.

16. The pigment of claim 15, wherein the aluminum flakes have a surface area (BET)≤3.5 m²/g.

17. The pigment of claim 1, wherein the aluminum flakes have a broadness of particle-size curve (Span) 1.1.

18. The pigment of claim 1, wherein the aluminum flakes have a hiding power ΣdE<15.

19. The pigment of claim 1, wherein the aluminum flakes have a hiding power ΣdE<13.

20. The pigment of claim 1, wherein the aluminum flakes have a lightness L*15>155.

21. The pigment of claim 2, wherein the metal content is 25-40 wt. %.
